(19) United States
(12) Patent Application Publication
(10) Pub. No.: US 2022/0234811 A1
(43) Pub. Date: Jul. 28, 2022

(54) CONTAINER SYSTEM INCLUDING LID WITH IMPROVED NECK INSULATION

(71) Applicant: Haishan Deng, Katy, TX (US)

(72) Inventor: Haishan Deng, Katy, TX (US)

(73) Assignee: GOVO, LLC, Katy, TX (US)

(21) Appl. No.: 17/160,354

(22) Filed: Jan. 27, 2021

(51) Int. Cl. B65D 81/38; B65D 41/04; B65D 85/72

(52) U.S. Cl. CPC B65D 81/3841; B65D 85/72; B65D 41/0414; B65D 81/3839

(57) ABSTRACT

The invention provides a container system comprising a lid and a container. The container includes a neck, and the lid includes a neck-surrounding space defined by two walls of the lid. At least the neck-surrounding space is vacuum insulated, or it is filled with foam, air, or any combination thereof. The lid exhibits numerous technical merits such as improved neck insulation, better efficiency in overall heat insulation, simplicity in usage, and easy manufacturability, among others.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### FIELD OF THE INVENTION

The present invention generally relates to a container system including a lid with an improved neck insulation. The container of the invention is Tillable or filled with a human drink such as water, coffee, beverages, sodas, and juices.

### BACKGROUND OF THE INVENTION

Conventional containers/bottles include a body or vessel for holding a fluid and a lid to prevent the fluid from spilling. Containers may hold a variety of different types of liquids and fluids. For instance, known containers may hold water, beverages, liquid refreshments, sodas, juices, thirst-quenchers, and the like. They may also hold fluids that require mixing, e g powdered drinks, electrolyte pills, energy drinks, baby formulas, pancake batters, crepe mixes, baking materials, dietary supplements, salsa, sauces, oil and vinegar, salad dressings, smoothies, and the like. Containers may be used in a wide variety of environments such as at home, office, gym, or health club; while traveling; or during activities such as exercising, gardening, playing games or sports, hiking, climbing, working, commuting, driving a car, or riding in an automobile, bus, train, or airplane.

Insulated bottles can maintain the temperature of the drink. For example, if a user wants his/her water to stay cold, the user can just drop a few ice cubes in the bottle, and the water will maintain a refreshingly crisp temperature for hours, even if the user leaves it in a hot car. In cold winter days, when all the user really needs is a warm drink, insulated bottles can save the day too.

However, bottle neck is a part through which heat can, relatively speaking, easily transfer from inside to the outside, or from outside to the inside. A simple and effective insulation of the bottle neck remains a challenge in the industry Current container designs have a too complicated structure or provide insufficient insulation for the bottle neck. For example, United States Patent Application 2007/0131638 by Thadani discloses an insulated bottle as shown in FIG. 1. The device 5 has two major components, the receptacle that will store the closed bottle, and the closure capped bottle, which will contain the liquids. The bottle 6 with self-secured closure cap 7 forms the closure capped bottle and assembling the body 8 with its adapted upper cup 9 forms the receptacle. The upright, circular, externally threaded, thickest, open neck end of bottle 6 takes circular, internally threaded closure cap 7. Closure capped bottle 6 (+7) must be seated in body 8, and then upper cup 9 must be mated with body 8 to form the insulatory receptacle. The formed bottle 6 has a first upright, circular, narrow, externally threaded, thickest, open end neck portion 10, a neck downwards depending, gradually widening shoulder portion, a shoulder end depending, downwards, ribbed body portion 11, with a body end closed base portion 12. 13 shows the horizontal outward ribs on the bottle's upright body portion. 14 shows the maximum external width of the bottle. For secure closing, the open neck end 10 has external threads to take the adapted, circular, internally threaded, non-permanently fixed, removable and reusable closure cap 7. Closure cap 7 has a top flat circular portion with a depending downwards skirt internally threaded. Closure cap 7 is commonly known as a “single piece” cap. 15 shows the top flat of the closure cap 7. This is the place that will be held down by the body secured upper cup's inner base to hold fast the stored bottle within the formed receptacle. The receptacle body 8 will seat and hold the body of bottle 6. The body 8 will accept, seat, and enclose within itself, the bottle's base 12 and upright body portion 11, leaving the bottle's shoulder and neck outside itself. 16 shows the first open end of the body. 18 shows the inner base of the body on which the base 12 of the stored bottle will rest. 19 shows the least internal width of the body, this being as across opposite ribs opposite sides. Not shown in FIG. 1 is the outer grooves on body that, provide an improved grip while opening or closing the receptacle FIG. 1 shows that the maximum external width 14 of bottle 6 is less than the least internal width 19 of body 8. When bottle 6 is seated in body 8, with bottle base 12 resting on body base inner 18, the upright body portion 11 and base 12 of bottle 6 will not be held back by inner form of body 8. Thus, closure capped stored bottle 6 (+7) can be gripped by its narrow neck and removed from storing body through body's open end 16. FIG. 1 also shows the upper cup's base's inner flat side 22. 23 shows the least internal width of the upper cup, which, is also more than the maximum external width 14 of the bottle 6. 24 shows the outward, horizontal, flat ring part of the upper cup. 25 shows the flat ring end, downward depending, internally threaded skirt.

United States Patent Application 2017/0166385 by Pisarevsky discloses an insulating container for a beverage bottle that compromises a container lower body, a container upper body, and a swiveling carrying handle. The insulating container includes a hollow interior space sized to receive a longneck beverage bottle. The inner walls of the container lower body and the container upper body are lined with foam or other suitable material configured to provide protection and stability in the event of breakage and spillage especially when transporting the container. The inner liner of the container upper body includes an aperture sized to receive the top portion of the longneck beverage. FIG. 2 illustrates a cross sectional view of an insulating container 500 for a beverage container. A container lower body 502 is sized to receive various types of beverage containers. The size and shape of the container lower body 502 is configured to removably receive the beverage container. The size and shape of the container upper body 504, the foam insert 505, and the aperture 506 are configured to removably receive a beverage container to provide protection from breakage and spillage, and an alternative closure. The container upper body 504 may include an integrated carrying handle 507 configured to swivel to an open, upright position to carry the container, and a closed position to store the container. The insulating container 500 may use a sealable coupling mechanism 508 such as a threaded mechanism (e.g male thread and female thread) to couple the container upper body 504 to the container lower body 502 to prevent spillage and to ensure an air-tight assembly.

United States Patent Application 2018/0020855 by Wang teaches a heat insulation bottle as shown in FIGS. 3A, 3B and 3C. The heat insulation bottle comprises a bottle body 20, a bottle head 30, a flexible bushing 40, a bottle cover 50 and a straw 60. The bottle body 20 defines therein an accommodation chamber 21 and a concave arc portion in a bottom side of the accommodation chamber 21. The bottle head 30 comprises a bottle mouth 33 located at a top side thereof with an opening 331 therein, a guide surface 34 located at an opposing bottom side thereof. The guide surface 34 slopes upwardly toward a bottom side of the opening 331 of the bottle mouth 33. The bottom side of the bottle head 30 is detachably connected to a top side of the bottle body 20, keeping the opening 331 of the bottle mouth 33 in communication with the accommodation chamber 21. The bottle head 30 further comprises an air vent 35 in communication between the accommodation chamber 21 and the outside. The bottle head 30 consists of a base member 31 and a cap member 32. The base member 31 comprises a connection segment 311 detachably connected to the bottle body 20, an inner conical segment 312 connected to the connection segment 311 and defining therein the said guide surface 34, and an inner tube segment 313 connected to the inner conical segment 312 opposite to the connection segment 311. The cap member 32 comprises an outer tube segment 321 capped on the inner tube segment 313, and an outer conical segment 322 attached onto the inner conical segment 312. The inner tube segment 313 and the outer tube segment 321 are composed to create the bottle mouth 33. The flexible bushing 40 is accommodated in the inner tube segment 313. The outer tube segment 321 defines an upper wall 3211 at a top side thereof. The upper wall 3211 defines a hole therein at the center. The inner tube segment 313 defines a lower wall 3131 at a top side thereof. The lower wall 3131 defines a hole therein at the center. The diameter of the hole in the upper wall 3211 and the diameter of the hole in the lower wall 3131 are larger than the outer diameter of the flexible bushing 40. The flexible bushing 40 is made of a flexible material and mounted in the opening 331 of the bottle mouth 33 with a top end thereof stopped by the upper wall 3211 and the lower wall 3131, and therefore, the flexible bushing 40 is prohibited from falling out of the opening 331 of the bottle mouth 33. After removal of the cap member 32 from the base member 31 through a rotary motion, the user can take the flexible bushing 40 out of the bottle mouth 33 for cleaning or replacement. The bottle cover 50 is fastened to the bottle head 30 to block the opening 331 of the bottle mouth 33. The bottle cover 50 is a snap bottle cover design, having one end thereof pivotally connected to the bottle head 30 and an opposite end thereof terminating in a fastener 51 for fastening the bottle cover 50 to the bottle head 30. The bottle cover 50 defines in an inner top side thereof an annular flange 52 that is detachably attached onto the bottle mouth 33. The straw 60 has a beveled edge 61 at one end thereof, defining therein a side opening. The length of the straw 60 is longer than the distance between the concave arc portion 22 of the bottle body 20 and an opposing bottom end of the flexible bushing 40, but shorter than the distance between the concave arc portion 22 of the bottle body 20 and the top end of the flexible bushing 40, thus, the straw 60 has its one end stopped at the lowest area of the concave arc portion 22 and its other end inserted into the flexible bushing 40.

United States Patent Application 20130277327 by FONG discloses a heat-insulation safety nursing bottle as shown in FIG. 4. The nursing bottle comprises a nursing bottle body 2, a nipple 23 fastened to the nursing bottle body 2, and a heat shield 1 surrounding the nursing bottle body 2. The heat shield 1 comprises a cylindrical heat shield body 11, which comprises an outer thread 111 extending around the periphery near the topmost edge thereof, and a heat shield cap 12, which comprises a first inner thread 121 disposed near a bottom side thereof and threaded onto the outer thread 111 of the cylindrical heat shield body 11, a center mounting through hole 122, and a second inner thread 123 spaced above the first inner thread 121 and disposed adjacent to the center mounting through hole 122. The nursing bottle body 2 comprises a bottleneck 21, and an outer thread 22 extending around the periphery of the bottleneck 21. The second inner thread 123 of the heat shield cap 12 is threaded onto the outer thread 22 of the nursing bottle body 2 to lock the nipple 23 to the bottleneck 21 of the nursing bottle body 2. When the nursing bottle is assembled, the heat shield cap 12 of the heat shield 1 is secured to the bottleneck 21 of the nursing bottle body 2, and the cylindrical heat shield body 11 of the heat shield 1 is spaced around the nursing bottle body 2, avoiding direct transfer of heat from the milk in the nursing bottle body 2 to the cylindrical heat shield body 11 of the heat shield 1, and therefore the cylindrical heat shield body 11 does not scald the user's hand. Further, the cylindrical heat shield body 11 of the heat shield 1 protects the nursing bottle body 2 against breaking. Even if the nursing bottle body 2 is broken, the broken chips can be kept inside the cylindrical heat shield body 11 of the heat shield 1, prohibiting the baby from touching or eating the broken chips.

U.S. Pat. No. 4,303,180 to Sheu discloses a vacuum insulated, heat retaining, liquid dispensing bottle as shown in FIG. 5. The bottle includes an outer bottle body 10, a bottle cover 12, an internal bottle 14 installed within the outer bottle body 10 and spaced therefrom to preclude heat loss, a siphon pipe 16 extending deeply into the internal bottle 14, a discharge pipe 20 with an upper end connected to the siphon pipe and a lower end extending out of the outer bottle body 10 having a discharge valve 18 which looks like a faucet, and a bottle stopper 22 with a compressed air mechanism. The discharge pipe 20 is disposed substantially entirely inside the bottle body 10 or equipped between the bottle body 10 and internal bottle 14. The upper end of the discharge pipe 20 has been engraved with screw threads and is extended to over the opening 48 of bottle body 10, and the other end, the lower end, is anchored between the bottle body 10 and the internal bottle 14 by means of a fixture 24 and further extends out of the bottle body 10 in which has a discharge switch 18 like a faucet. The bottom end of the siphon pipe 16 extends deeply into the inner side of the internal bottle 14, with an upper end of the siphon pipe 16, having been engraved with screw threads and a further projecting part, so that said projecting part may combine and engage with an upper end of said discharge pipe 20 by means of a threaded connector 44 having screw threads in its inner wall. In such an arrangement siphon pipe 16 and the discharge pipe 10, will become a communicating pipe. The bottle stopper 22 is designed to be a centrally spaced ring housing, having an opening on top side and air holes 40 on bottom side, in which the ring housing is disposed within its inner side with a ring-shaped member 34 which closely engages with the housing and also extends upward as a pressing portion 36. Also, a coil compressed spring 38 is set on the bottom side of the ring-shaped member 34 which is within the housing. After liquid is poured into the internal bottle 14 for storage without heat loss, the liquid within the internal bottle 14 will be easily absorbed into the discharge pipe 20 through the siphon pipe 16 because the calibers of both the siphon pipe 16 and the discharge pipe 20 are all small. Also, the opening 42 on the upper side of the internal bottle 14 is corked by a bottle stopper 22. Therefore, when liquid within the internal bottle 14 is less than a level which is the least degree of liquid able to be absorbed into the discharge pipe 20 through the siphon pipe 16, if necessary, the pressing portion 36 provided on the bottle stopper 22 may be pressed so as to force air within the housing 32 into the internal bottle 14 through the air hole adding pressure on the surface of liquid to have liquid absorbed into the discharge pipe 20 through the siphon pipe 16. However, due to the lower end of the discharge pipe 20 being in normally closed condition, the above-described operation will fill the siphon pipe 16 and the discharge pipe 20. Therefore, when it is desirous to dispense water after the bottle is covered by the bottle cover 12, is only necessary to open the discharge valve 18 which is on the outside of the bottle without opening the bottle cover 12 or any other handed operations so water will readily and quickly flow out without tipping the bottle from an erect position. And when the discharge switch valve is switched off, water will also immediately stop flowing out. At this time, water still fills the siphon pipe 16 and the discharge pipe 20, thus water will be also immediately flowing out after opening or switching on the valve 18 even though the discharge valve 18 has been switched on and off for many times in continuity.

Advantageously, the present invention provides a container system comprising a lid and a container. The container includes a neck, and the lid includes a neck-surrounding space defined by two walls of the lid. At least the neck-surrounding space is vacuum insulated, or it is filled with foam, air, or any combination thereof. The lid exhibits numerous technical merits such as improved neck insulation, better efficiency in heat insulation, simplicity in usage, and easy manufacturability, among others.

### SUMMARY OF THE INVENTION

One aspect of the present invention provides a container system comprising a lid and a container. The lid is sized and configured to be attached to the container, which is finable or filled with a human drink such as water, coffee, beverages, sodas, and juices. The container comprises a mouth having an opening defined by a cylindrical neck wall for dispensing the human drink. The lid comprises an upper cover, a lower cover, and a peripheral wall (which is preferably closed) located between the upper cover and the lower cover and configured to connect the two covers. The lower cover comprises a circular trench (upside-down) surrounding a round island (upside-down). The cylindrical wall of the mouth is configured to insert into (and preferably fasten to) the circular trench, while the island is configured to plug into the opening (and preferably seal the opening). The circular trench is within the peripheral wall, and a space is formed between the peripheral wall and an outer vertical wall of the circular trench. At least the space is vacuum insulated, or it is filled with foam, air, or any combination thereof.

The above features and advantages and other features and advantages of the present invention are readily apparent from the following detailed description of the best modes for carrying out the invention when taken in connection with the accompanying drawings.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements. All the figures are schematic and generally only show parts which are necessary in order to elucidate the invention. For simplicity and clarity of illustration, elements shown in the figures and discussed below have not necessarily been drawn to scale. Well-known structures and devices are shown in simplified form, omitted, or merely suggested, in order to avoid unnecessarily obscuring the present invention.

FIG. 1 shows an insulated bottle in the prior art.

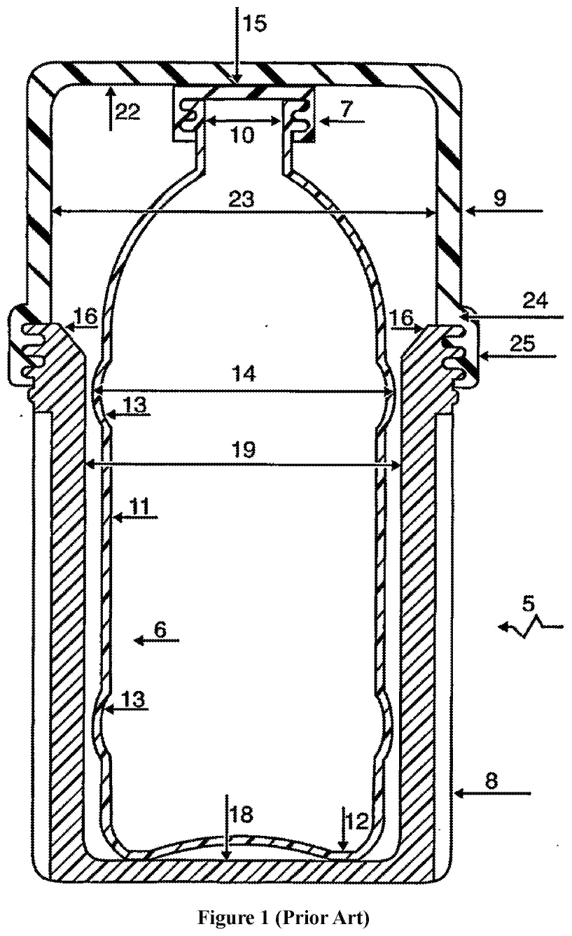

FIG. 2 shows an insulating container for a beverage bottle in the prior art.

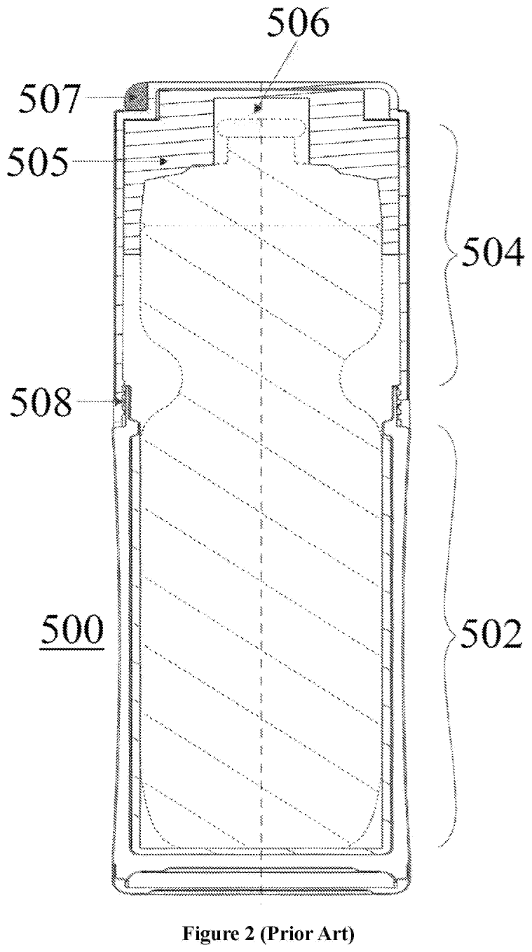

FIG. 3A is an oblique top elevational view of a heat insulation bottle in the prior art.

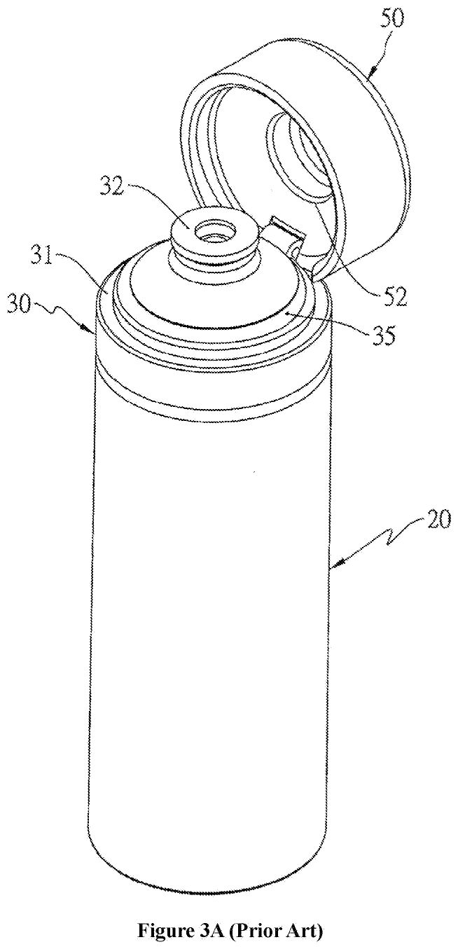

FIG. 3B is an exploded vim of the heat insulation bottle in FIG. 3A.

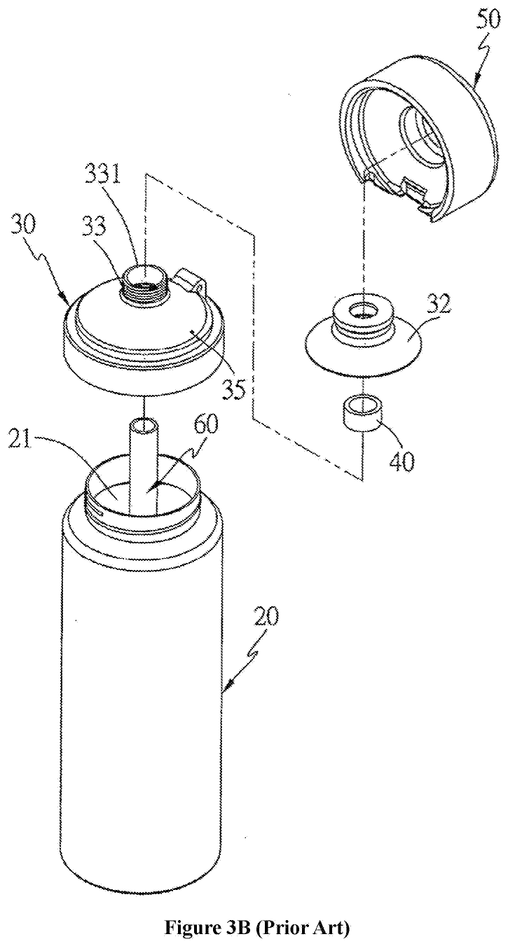

FIG. 3C is a sectional view of an upper part of the heat insulation bottle in FIG. 3A.

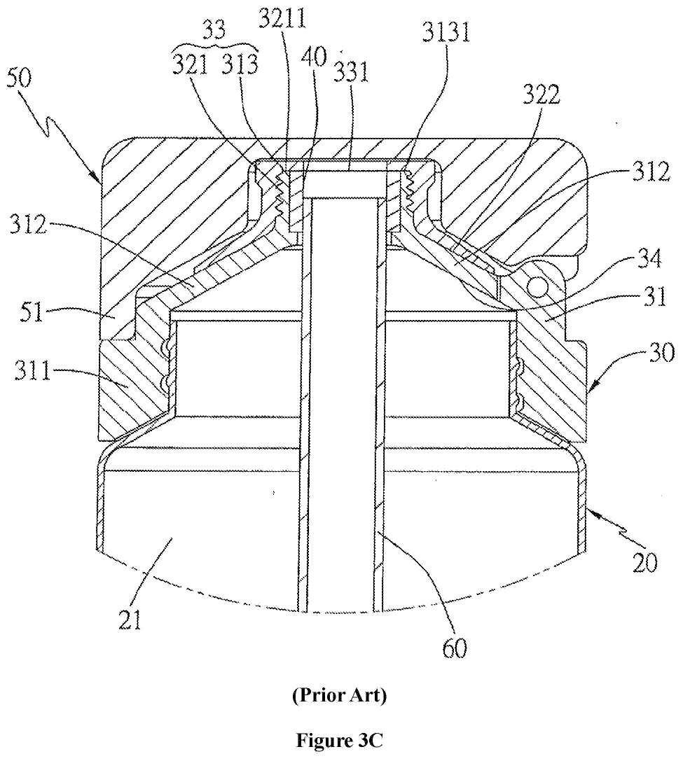

FIG. 4 is a sectional side view of a heat-insulation safety nursing bottle in the prior art.

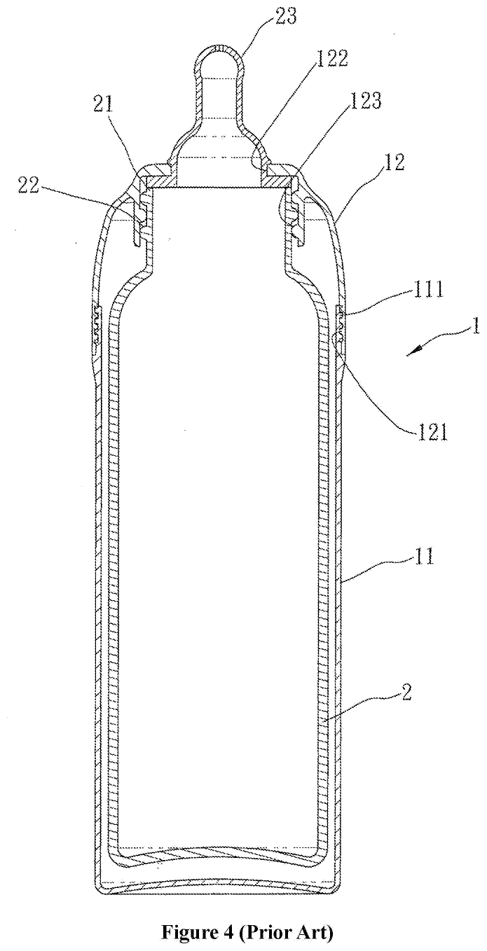

FIG. 5 is a longitudinally sectional view of a vacuum insulated bottle in the prior art.

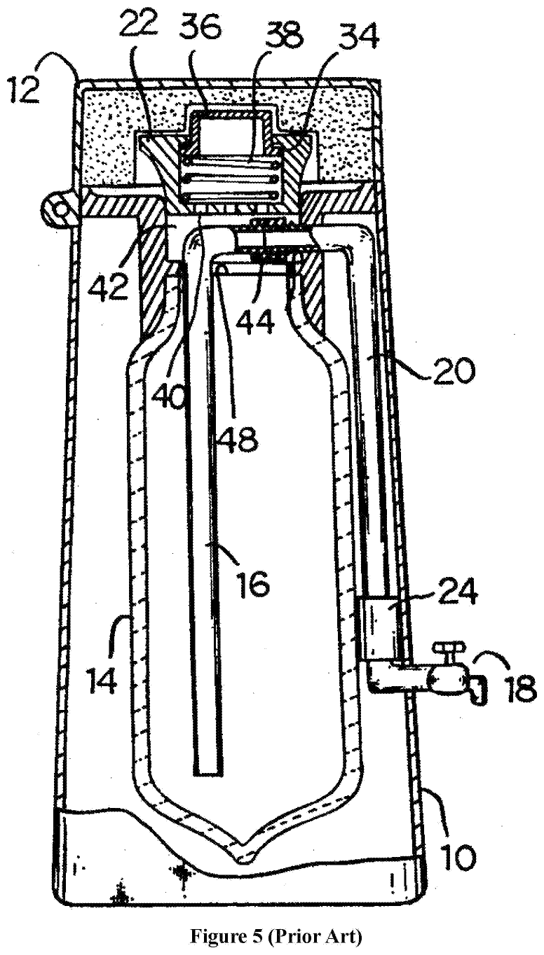

FIG. 6 illustrates a container system including a lid and a container in accordance with an exemplary embodiment of the present invention.

FIG. 7 illustrates a basic lid design in accordance with an exemplary embodiment of the present invention.

FIG. 8 illustrates a basic container body design in accordance with an exemplary embodiment of the present invention.

FIG. 9 illustrates a lid design including one or more reinforcement partition members in accordance with an exemplary embodiment of the present invention.

FIG. 10 is a sectional view schematically illustrating a lid design including reinforcement partition members of different shapes in accordance with an exemplary embodiment of the present invention.

FIG. 11 is a sectional view schematically illustrating a lid design including flat reinforcement partition members with different extension directions in accordance with an exemplary embodiment of the present invention.

FIG. 12 is a sectional view schematically illustrating a lid design including flat reinforcement partition members forming a grid in accordance with an exemplary embodiment of the present invention.

FIG. 13 is a sectional view schematically illustrating a lid design including flat reinforcement partition members forming another grid in accordance with an exemplary embodiment of the present invention.

FIG. 14 is a top isometric/perspective view of a container system in accordance with an exemplary embodiment of the present invention.

FIG. 15 is a bottom isometric/perspective view of the lid of the container system as shown in FIG. 14.

FIG. 16 shows a cutting plane line C-C of the container system as shown in FIG. 14.

FIG. 17 is a cross-sectional view of the container system as shown in FIG. 14.

FIG. 18 is a top front isometric/perspective view of the first modification based on the container system as shown in FIG. 14.

FIG. 19 shows a cutting plane line D-D of the container system as shown in FIG. 18.

FIG. 20 is a cross-sectional view of the container system as shown in FIG. 18.

FIG. 21 is an exploded isometric view of the lid in the container system as shown in FIG. 18.

FIG. 22 is a top isometric/perspective view of the second modification based on the container system as shown in FIG. 14.

FIG. 23 is a cross-sectional view of the container system as shown in FIG. 22.

FIG. 24 is an exploded isometric view of a lid in the container system as shown in FIG. 23.

FIG. 25 is a cross-sectional view of another lid in the container system as shown in FIG. 22.

FIG. 26 is a top front isometric/perspective view of the third modification based on the container system as shown in FIG. 14.

FIG. 27 is an exploded isometric view of the container system as shown in FIG. 26.

FIG. 28 is an exploded isometric view of the lid in the container system as shown in FIG. 26.

FIG. 29 shows two cutting plane lines A-A and B-B on top view of the container system as shown in FIG. 26.

FIG. 30 is a cross-sectional view of the container system as shown in FIG. 26 along the cutting plane line A-A.

FIG. 31 is a cross-sectional view of the container system as shown in FIG. 26 along the cutting plane line B-B.

FIG. 32 is a bottom isometric/perspective view of the lid in the container system as shown in FIG. 26, after its lower cover is removed.

FIG. 33 is a top front isometric/perspective view of the fourth modification based on the container system as shown in FIG. 14.

FIG. 34 shows a cutting plane line D-D on top view of the container system as shown in FIG. 33.

FIG. 35 is a cross-sectional view of the container system as shown in FIG. 33 along the cutting plane line D-D.

FIG. 36 is a cross-sectional view of the fifth modification based on the container system as shown in FIG. 14.

### DETAILED DESCRIPTION OF THE PREFERRED EMBODIMENT

In the following description, for the purposes of explanation, numerous specific details are set forth in order to provide a thorough understanding of the present invention. It is apparent, however, to one skilled in the art that the present invention may be practiced without these specific details or with an equivalent arrangement.

Where a numerical range is disclosed herein, unless otherwise specified, such range is continuous, inclusive of both the minimum and maximum values of the range as well as every value between such minimum and maximum values. Still further, where a range refers to integers, only the integers from the minimum value to and including the maximum value of such range are included. In addition, where multiple ranges are provided to describe a feature or characteristic, such ranges can be combined.

It is also to be understood that the terminology used herein is for the purpose of describing particular embodiments only, and is not intended to limit the scope of the invention. For example, when an element is referred to as being “on”, “connected to”, or “coupled to” another element, it can be directly on, connected or coupled to the other element or intervening elements may be present. In contrast, when an element is referred to as being “directly on”, “directly connected to”, or “directly coupled to” another element, there are no intervening elements present.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

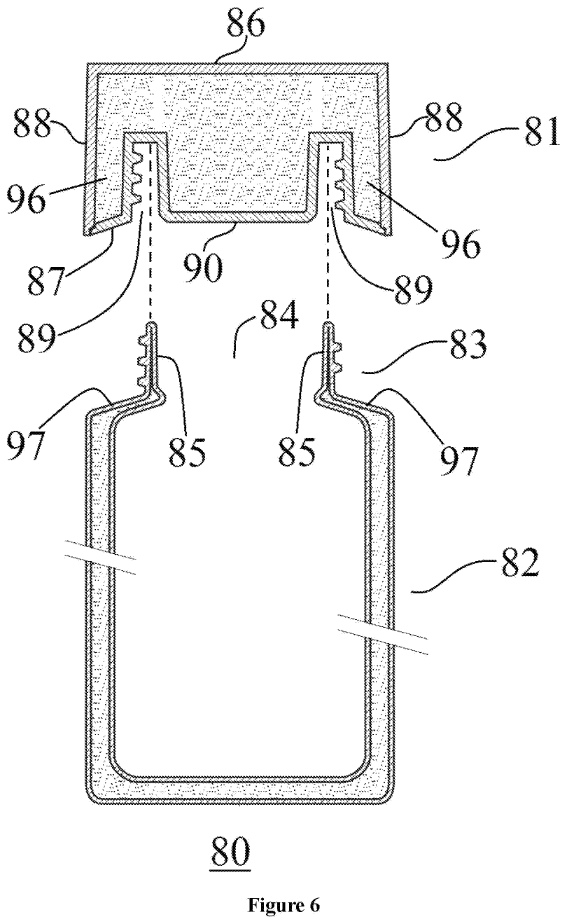

With reference to FIG. 6, a container system 80 includes a lid 81 and a container 82. The lid 81 is sized and configured to be attached to the container 82, which is Tillable or filled with a human drink such as water, coffee, beverages, sodas, and juices. The container 82 may be of any suitable material, including metal, plastic, glass, rubber, or any combinations thereof, and may be insulated or un-insulated. In one embodiment, the container 82 is formed from a plastic or other polymer material, which produces a flexible and/or squeezable container/bottle. In another embodiment, the container 82 may be formed of an insulated stainless steel, and which is fastened with a plastic or rubber base on the bottom (not shown) that provides protection for the bottom of the container as well as providing a relatively wide surface on which the container such as a beverage bottle is rested when standing. The base may be constructed of a plastic material, such as polypropylene, although other materials are also contemplated. In yet another embodiment, the container 82 may be of a double-walled construction, between which is an evacuated space, forming a so-called vacuum bottle/container. The container 82 may be flexible or rigid. A flexible container 82 permits the user to squeeze the container to force the content (e.g. liquid) from the container, while a rigid container 30 requires the user to draw the liquid out of the container 82 through suction or by pouring the liquid from the container 30. The container 30 may have a smooth or contoured surface that may be provided with patterns, such as by printing, painting, or embossing.

Referring to FIG. 6 again, container 82 includes a mouth 83 having an opening 84 defined by a cylindrical neck wall 85 for dispensing the human drink. Examples of lids/closures 81 include internally threaded bottle caps, externally threaded screw caps or tops, stoppers, toggle or swing-type closures, crown caps, flip-tops, and friction or interference fit lids. Typically, a lid is removably attached to the neck of a container so a user can remove the lid to add liquid, powders, ice, or other products into the container. The lid is then screwed or snapped onto the neck of the container to provide a generally watertight and leak-proof seal. When a user desires to drink liquid from the container, the lid may be removed by unscrewing the lid to provide access into the reservoir of the container. The user drinks from an opening formed by the neck of the container and then replaces the lid onto the container to re-seal the container. Lid 81 comprises an upper cover 86, a lower cover 87, and a peripheral wall 88 (which is preferably closed) located between the upper cover 86 and the lower cover 87 and configured to connect the two covers (86, 87). The lower cover 87 comprises a circular trench 89 (upside-down) surrounding a round island 90 (upside-down). The cylindrical wall 85 of the mouth 83 is configured to insert into (and preferably fasten to) the circular trench 89, while the island 90 is configured to plug into the opening 84, and preferably seal the opening 84. The circular trench 89 is within the peripheral wall 88, and hence, a space 96 is formed between the peripheral wall 88 and an outer vertical wall 892 of the circular trench 89. A part of or the entire space 96 is vacuum insulated, or filled with foam, air, or any combination thereof. In some embodiments, the entire space enclosed by the upper cover 86, lower cover 87, and the peripheral wall 88 is vacuum insulated, or it is filled with air, foam, or any combination thereof.

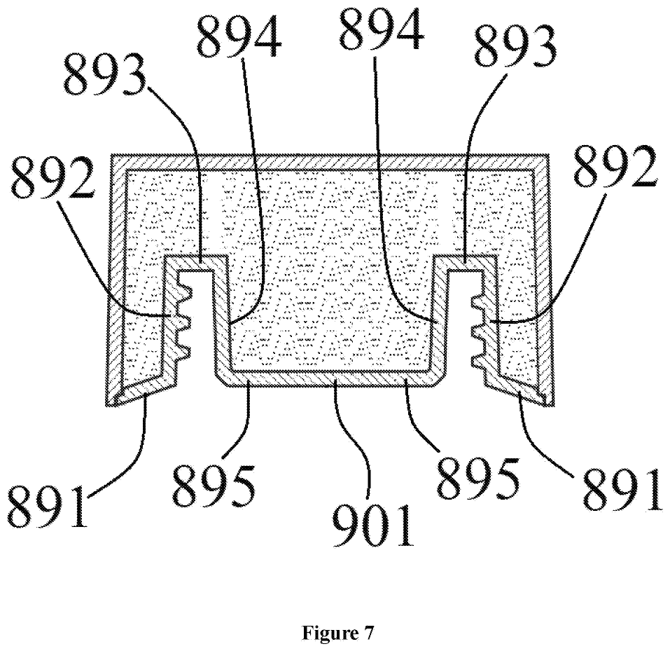

In various embodiments, the lower cover 87 is preferably continuous and it has no hole, but it may have one or more holes. As shown in FIG. 7, the lower cover 87 may include, from the outermost to the innermost, a trench outward bank 891, a trench outer vertical wall 892, a trench base 893, a trench inner vertical wall 894, and a trench inward bank 895, and a central region 901 of the round island 90. It should be appreciated that the trench inward bank 895 is also the circumference region of the round island 90. The diameter of the central region 901 of the round island 90 may be less than 90%, 80% or 70% of the diameter of the round island 90. The trench outward bank 891 has a shape that conforms to a shoulder 97 of the container 82. In one embodiment, the lid 81 and the container 82 are coaxial and have substantially the same diameter. At least, they have substantially the same diameter at the junction where the trench outward bank 891 and the shoulder 97 meet and contact intimately. In other words, the maximal diameter of the trench outward bank 891 and the maximal diameter of the shoulder 97 may be substantially the same. In some embodiments, the trench outward bank 891 is flat, curved, angled, or just a point of intersection of the peripheral wall 88 and the outer vertical wall 892 of the circular trench 89. Preferably, the shoulder 97 has a size same as, and has a surface or shape complementary to, the trench outward bank 891, so that they can intimately contact each other. For example, both the shoulder 97 and the trench outward bank 891 may be flat and having a same downward slope.

In various embodiments, the maximal diameter of the outer vertical wall 892 is about 30-95%, 40-95%, 40-90%, 50-90%, 60-85%, 70-85%, 75-85%, or 75-80% of the maximal diameter of the peripheral wall 88. As a result, the space 96 between the peripheral wall 88 and an outer vertical wall 892 of the circular trench 89 may have a width (or a radial length as measured along the direction radial from the center of the circular trench 89 or the round island 90). The width or the radial length of the space 96 may be about 5-40%, 5-30%, 10-30%, 10-20%, or 15-20% of the radius (or the maximal radius if wall 88 thickness is accounted) of the peripheral wall 88. The trench outward bank 891 may be flat and have a length greater than 0, 0.01 mm, 0.05 mm, 0.1 mm, 0.2 mm, 0.5 mm, 1.0 mm, 1.5 mm, 2.0 mm, 2.5 mm, 3.0 mm, 3.5 mm, 3.5 mm, or 4.0 mm, wherein the length is measured along a direction radial from the center of the circular trench 89 or the round island 90.

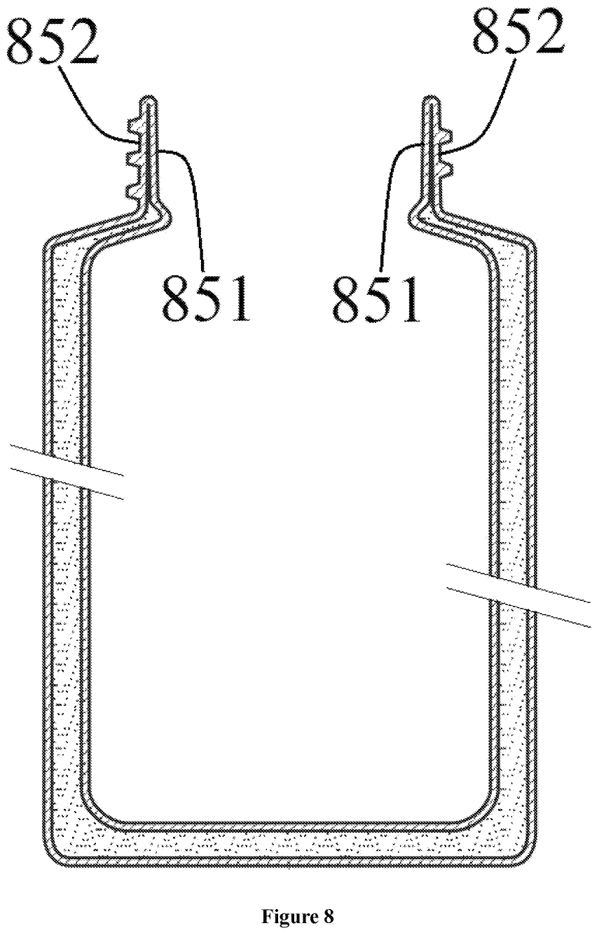

The cylindrical wall 85 of the mouth 83 as shown in FIG. 6 is fastened/secured to the circular trench 89 by any attaching or fastening structures, such as a threaded connection (e neck finish), a friction fit, interference fit, snap fit, fastener, clips, a bayonet attachment, or any combination thereof. In an embodiment as shown in FIG. 8, the cylindrical wall 85 of the mouth 83 has an internal wall 851 and an external wall 852. The attaching or fastening structure comprises threads on the internal wall 851 and complimentary threads on the trench inner vertical wall 894 as shown in FIG. 7. For example, the attaching or fastening structure may include threads on the external wall 852 and complimentary threads on the trench outer vertical wall 892.

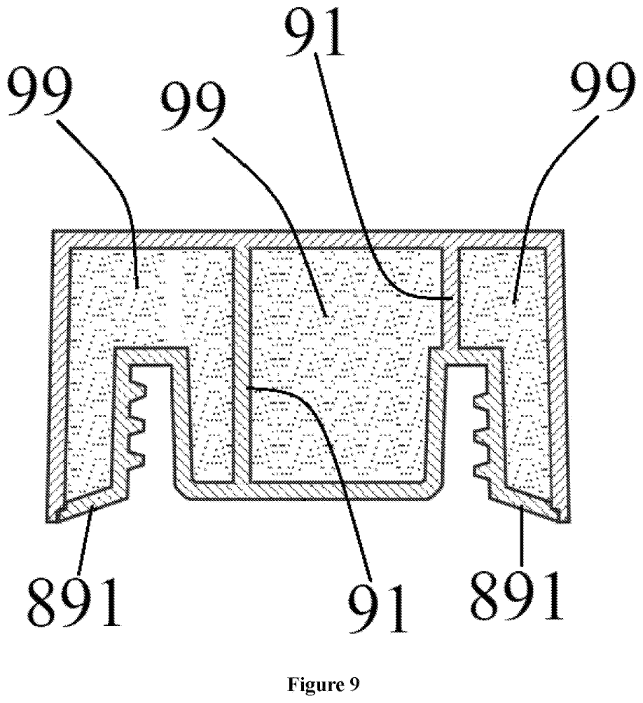

With reference to FIG. 9, the container system 80 of the present invention may additionally include one or more reinforcement partition members 91 (such as walls 91) within the space enclosed by the upper cover 86, lower cover 87, and the peripheral wall 88. When two or more reinforcement partition members 91 are present, any two of these partition members 91 are separated from each other or connected to each other Typically, the one or more reinforcement partition members 91 are substantially vertical; but it or they may not be substantially vertical, for example, substantially horizontal. These reinforcement partition members 91 may divide the space enclosed by the upper cover 86, lower cover 87, and the enclosed wall 88 into two or more chambers 99. These chambers 99 may be completely separated from each other, or partially connected to each other. In preferred embodiments, these chambers 99 are vacuum insulated, or they are filled with air, foam, or any combination thereof.

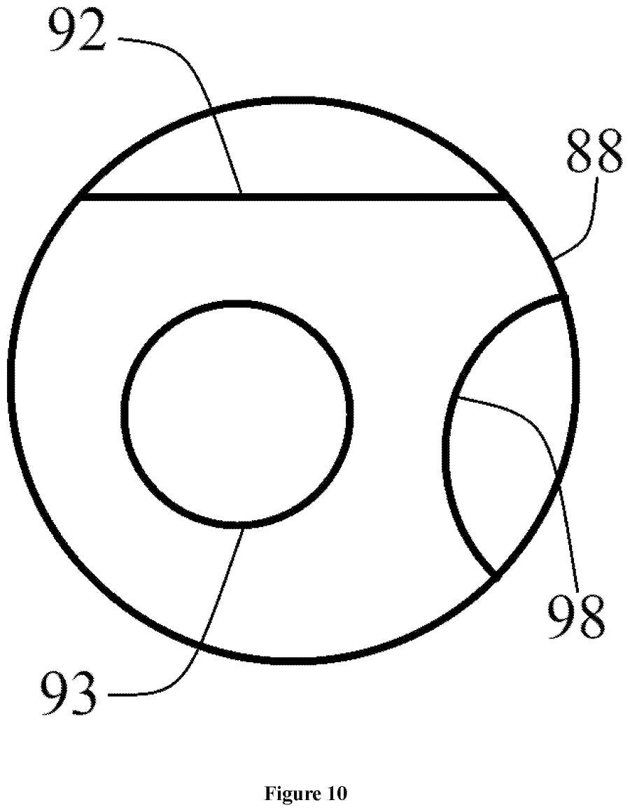

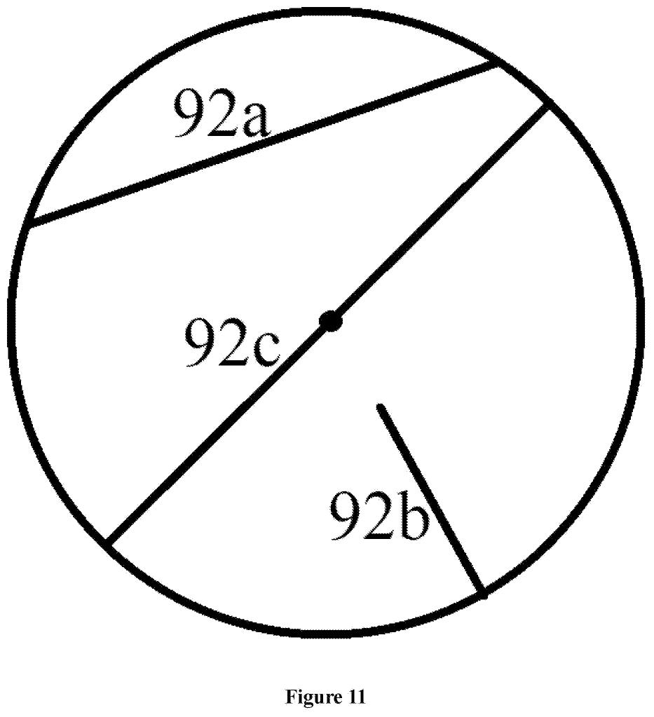

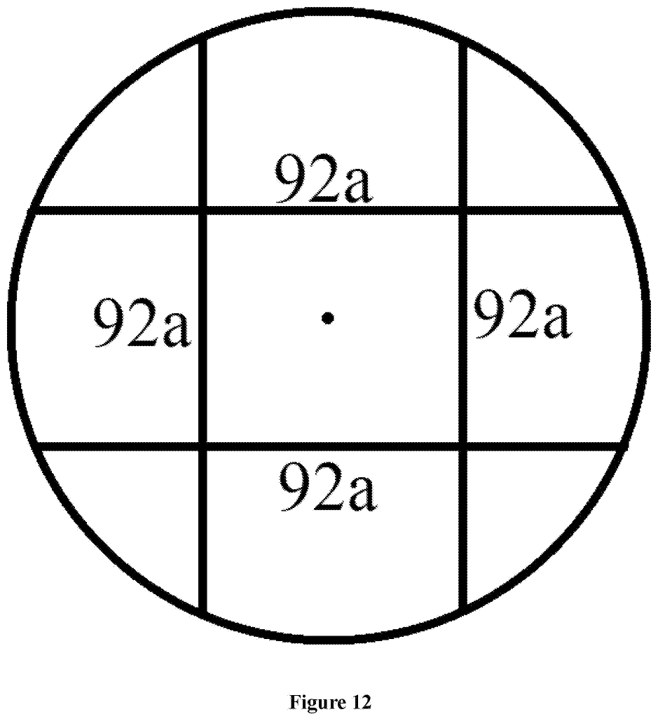

With reference to FIG. 10, the one or more reinforcement partition members 91 may include a flat partition member 92, a curved partition member 98, a circular partition member 93, or any combination thereof. For example, FIG. 11 schematically shows that a flat partition member 92a may be extended along a chord direction of the circular trench 89 or the round island 90, but not along a direction radial from the center of the circular trench 89 or the round island 90. Another flat partition member 92b may be extended along a direction radial from the center of the circular trench 89 or the round island 90. Still another flat partition member 92c may be extended along a diameter direction of the circular trench 89 or the round island 90 FIG. 12 is a top view showing that a circular partition member 93a is not concentrical with the circular trench 89 or the round island 90, while another circular partition member 93b is concentrical with the circular trench 89 or the round island 90.

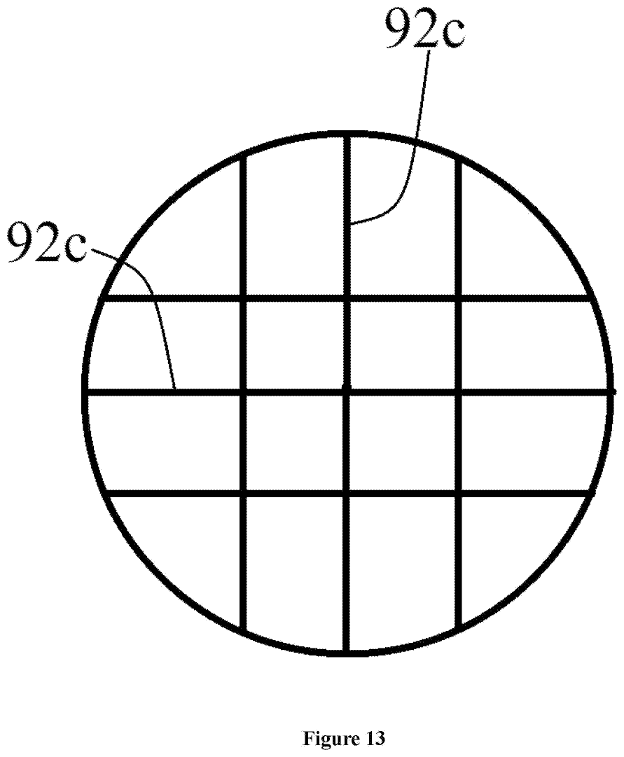

As shown in FIG. 12, a plurality of flat partition members 92a are extended along chords' direction (such as chords in parallel with each other and perpendicular to each other) of the circular trench 89 or the round island 90, but are not along a direction radial from the center thereof. These partition members 92a may form a grid. Alternatively, as shown in FIG. 13, these partition members 92a together with one or two flat partition members 92c that are extended along a diameter direction of the circular trench 89 or the round island 90, may form a grid of partition members 92.

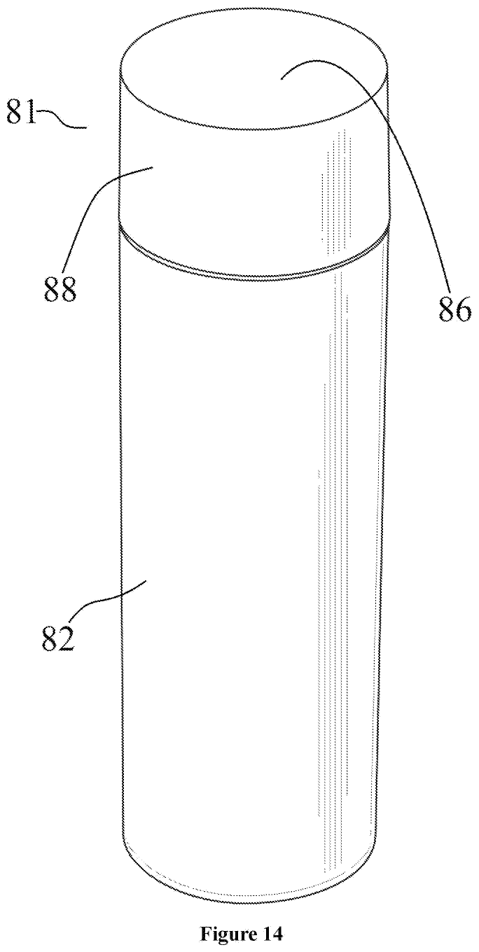

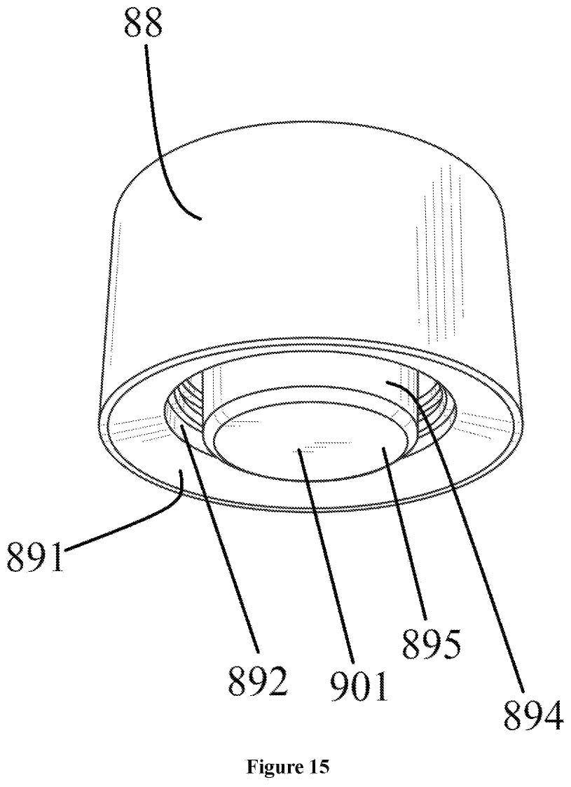

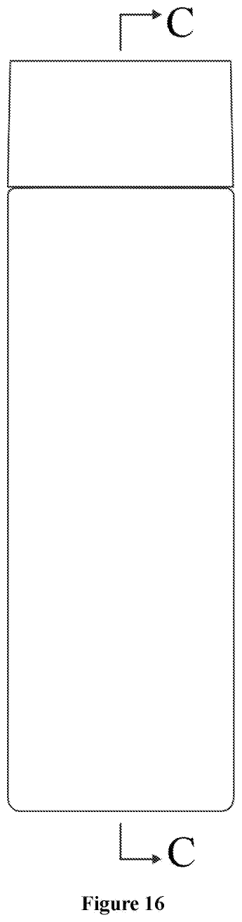

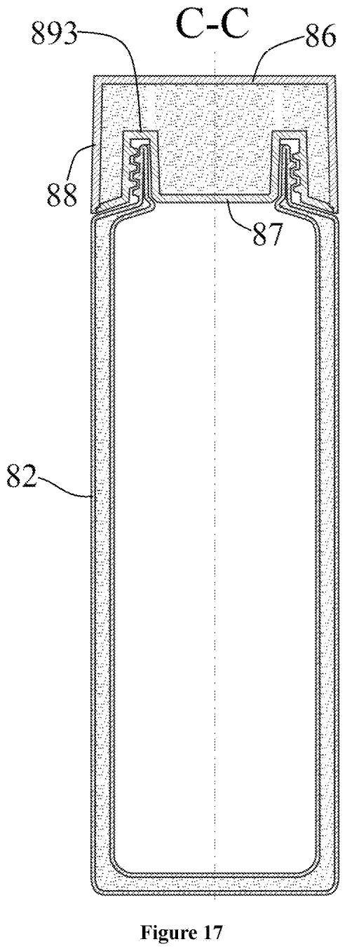

FIGS. 14-17 illustrate a basic example of container system 80. As shown in FIG. 14, the upper cover 86 is substantially flat and round, and the peripheral wall 88 is substantially cylindrical. The lid 81 and the container 82 have substantially the same diameter. Referring to FIG. 15, the lower cover 87 may include, from the outermost to the innermost, a trench outward bank 891, a trench outer vertical wall 892, a trench base 893 (not shown), a trench inner vertical wall 894, and a trench inward bank 895, and a central region 901 of the round island 90. It should be appreciated that the trench inward bank 895 is also the circumference region of the round island 90. A cutting plane represented by the cutting plane line C-C as shown in FIG. 16 provides a cross-sectional view of the container system as shown in FIG. 17, in which the trench base 893 is visible. The container system 80 in FIG. 17 does not include any reinforcement partition members 91 (such as walls 91) within the space enclosed by the upper cover 86, lower cover 87, and the peripheral wall 88. The container 82 may have a double-walled construction, between which is an evacuated space, forming a so-called vacuum bottle/container.

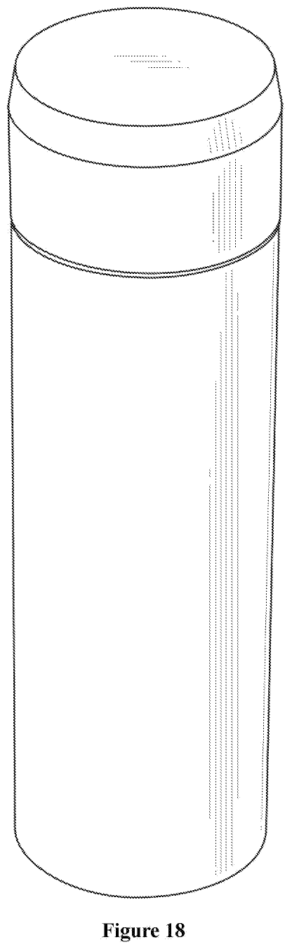

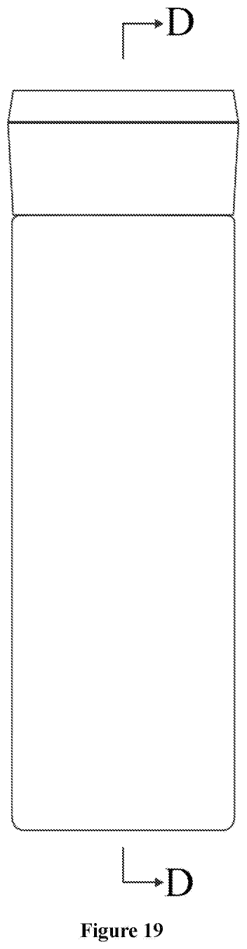

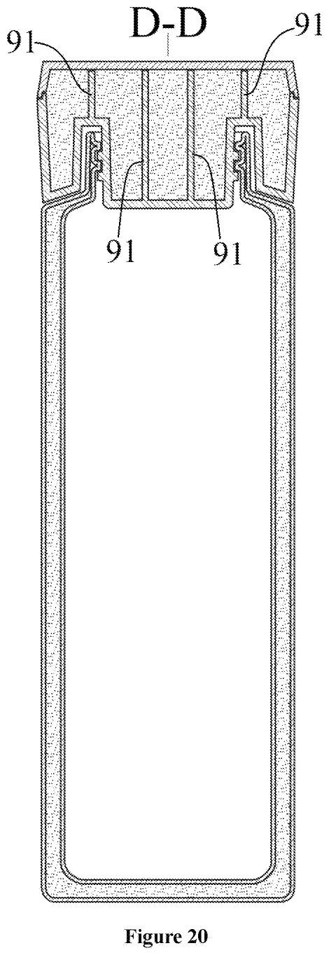

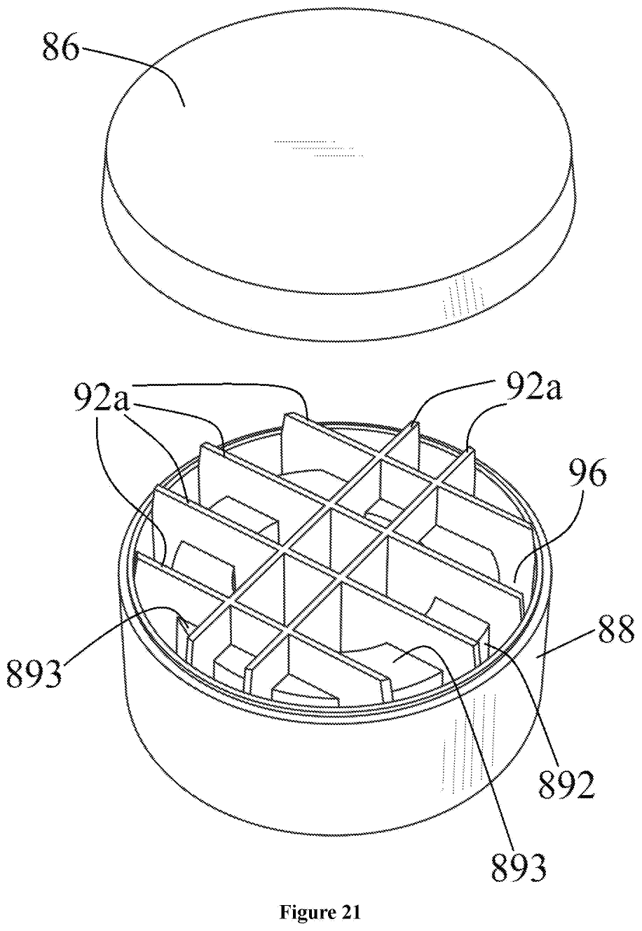

FIGS. 18-21 illustrate a first modification of the basic example of container system 80 as shown in FIGS. 14-17. As shown in FIG. 18, the upper cover 86 is substantially flat and round, but the peripheral wall 88 has varying diameters. A cutting plane represented by the cutting plane line C-C as shown in FIG. 19 provides a cross-sectional view of the container system as shown in FIG. 20, in which one or more reinforcement partition members 91 (such as walls 91) are present within the space enclosed by the upper cover 86, lower cover 87, and the peripheral wall 88. Referring to FIG. 21, a plurality of flat partition members 92a are extended along chords' direction of the circular trench 89 or the round island 90, but are not along a direction radial from the center thereof. For example, 4 out of 6 flat partition members 92a are extended along 4 parallel chords and the other 2 are extended along 2 parallel chords that are perpendicular to the 4 parallel chords, forming a 2×4 grid of partition members 92a. Alternatively, these partition members 92a together with one or two flat partition members 92c (not shown) that are extended along a diameter direction of the circular trench 89 or the round island 90, may form another grid of partition members 92. The space 96 is formed between the peripheral wall 88 and the outer vertical wall 892 of the circular trench 89.

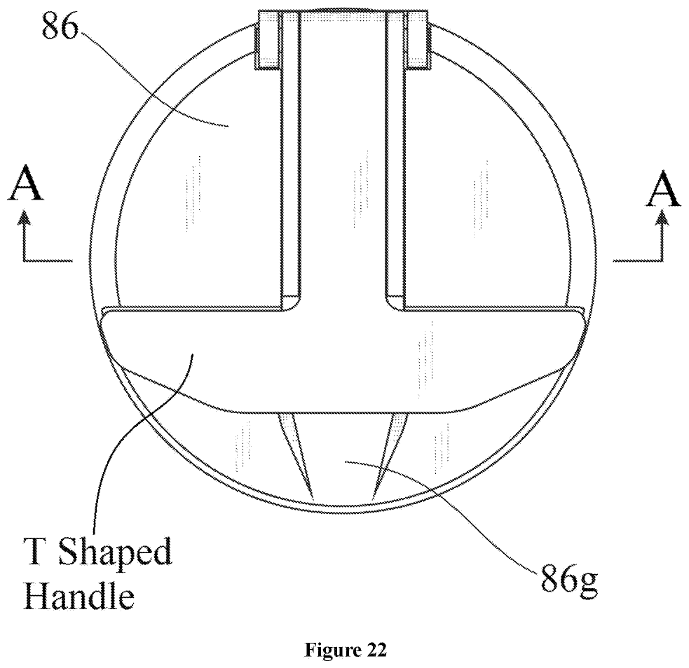

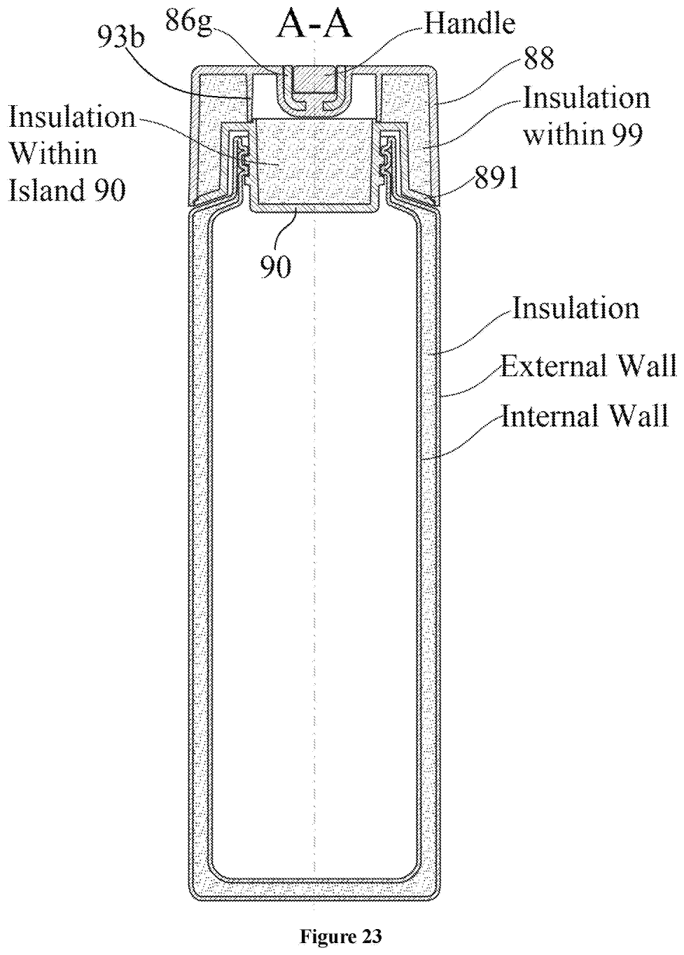

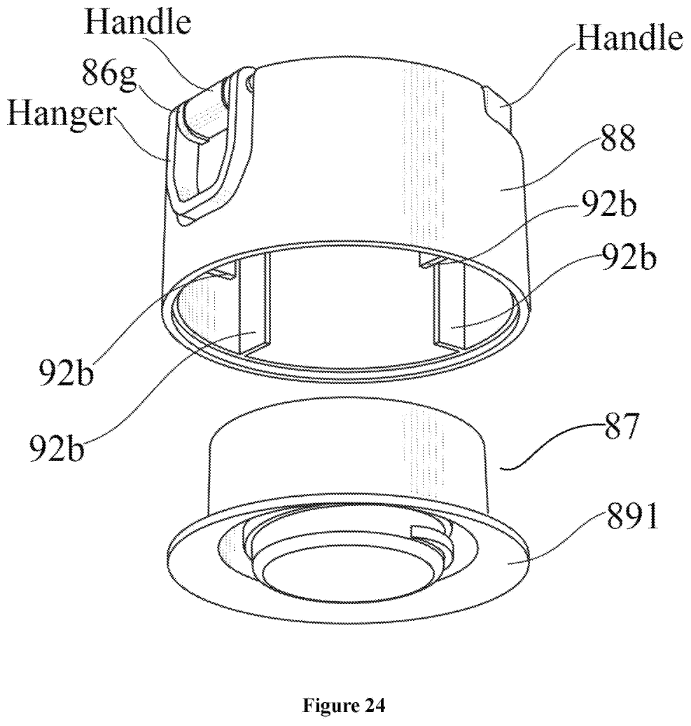

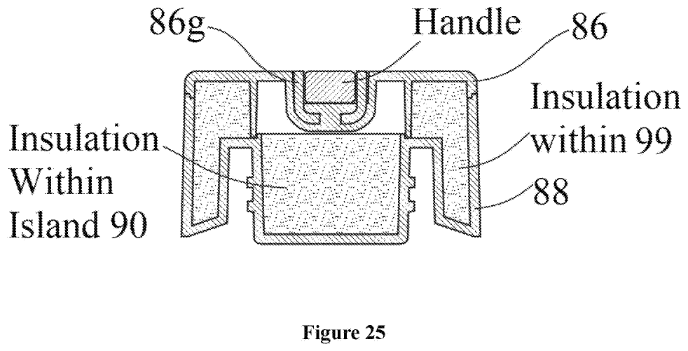

FIGS. 22-25 illustrate a second modification of the basic example of container system 80 as shown in FIGS. 14-17. As shown in FIG. 22, the upper cover 86 is not substantially flat and round. Instead, the upper cover 86 has irregularity or irregularities such as hole(s), groove(s), basin(s), plateau(s), or any combination thereof. For example, a groove 86g is present on the upper cover 86. FIG. 23 shows that the groove 86g may be designed to house a handle attached to the lid 81. The body of the container 82 is constructed of an external wall, an internal wall, and insulation material filled between the two walls. There is also insulation material filled within the island 90 and chambers 99. A circular partition member 93b vertically spanning from the trench base 893 to the upper cover 86 is concentrical with the circular trench 89 or the round island 90. The upper cover 86 and the peripheral wall 88 may be included in a single molded piece, and the lower cover 87 is included in another single molded piece. In such an embodiment. The peripheral wall 88 may be a cylindrical sidewall extending downward from an outer perimeter of the upper cover 86. In an alternative embodiment (not shown), the lower cover 87 and the peripheral wall 88 are included in a single molded piece, and the upper cover 86 is included in another single molded piece. In another alternative embodiment (not shown), the upper cover 86 is included in a first single molded piece, the peripheral wall 88 is included in a second single molded piece, and the lower cover 87 is included in a third single molded piece. In FIG. 24, four flat partition member 92b may be evenly distributed within a single space consisting of the space 96 and the space between the circular partition member 93b and the peripheral wall 88. The four flat partition member 92b may be extended along a direction radial from the center of the circular trench 89 or the round island 90. The four flat partition member 92b may divide the above single space into four chambers 99. The peripheral wall 88 in FIG. 24 may have irregularity or irregularities such as hole(s), cavity or cavities, flat(s), groove(s), or any combination thereof. For example, a hanger recess on peripheral wall 88 may be needed to accommodate a hanger such as a loop, a hook, or a clip. For example, the hanger can be a loop sufficiently strong to support carrying of the container 82 by the loop when the container 82 is full of content such as liquid. The hanger may provide a convenient method of attaching the container system 80 to a backpack, gym bag or the like. In an embodiment as shown in FIG. 25, the upper cover 86 and a part of the peripheral wall 88 are included in a single molded piece; and the lower cover 87 and the remaining part of the peripheral wall 88 are included in a single molded piece.

When one or more reinforcement partition members 91 are present, it should be appreciated that all the one or more reinforcement partition members 91 and the upper cover 86 may be included in a single molded piece. All the one or more reinforcement partition members 91 and the lower cover 87 may be included in a single molded piece. All the one or more reinforcement partition members 91 and the peripheral wall 88 may be included in a single molded piece. Alternatively, the one or more reinforcement partition members 91 may be separated into 2 or 3 parts. The 2 or 3 parts and any 2 or all 3 of the upper cover 86, the lower cover 87, and the peripheral wall 88 may be included in 2 or 3 single molded pieces, respectively.

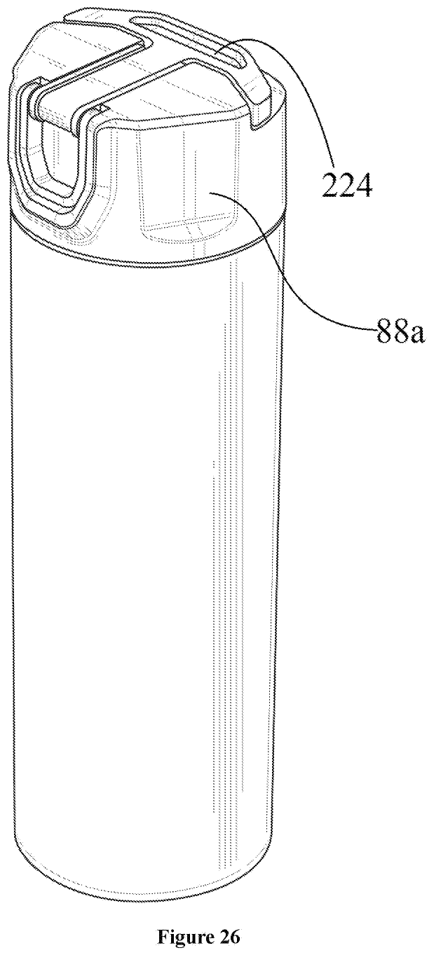

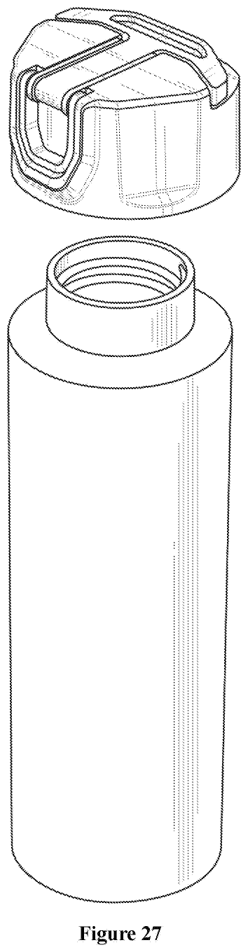

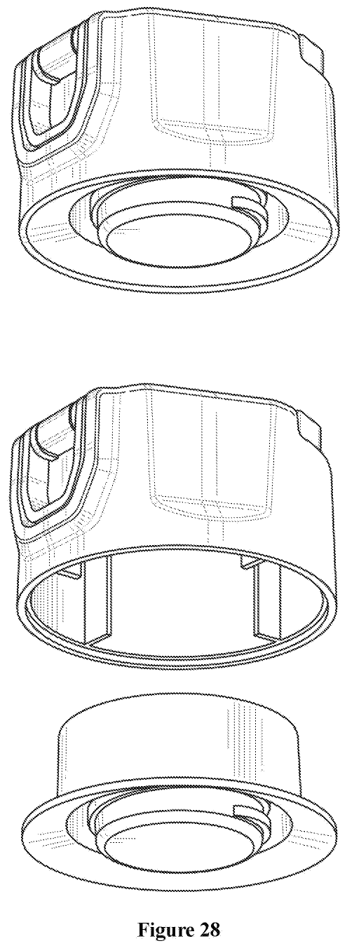

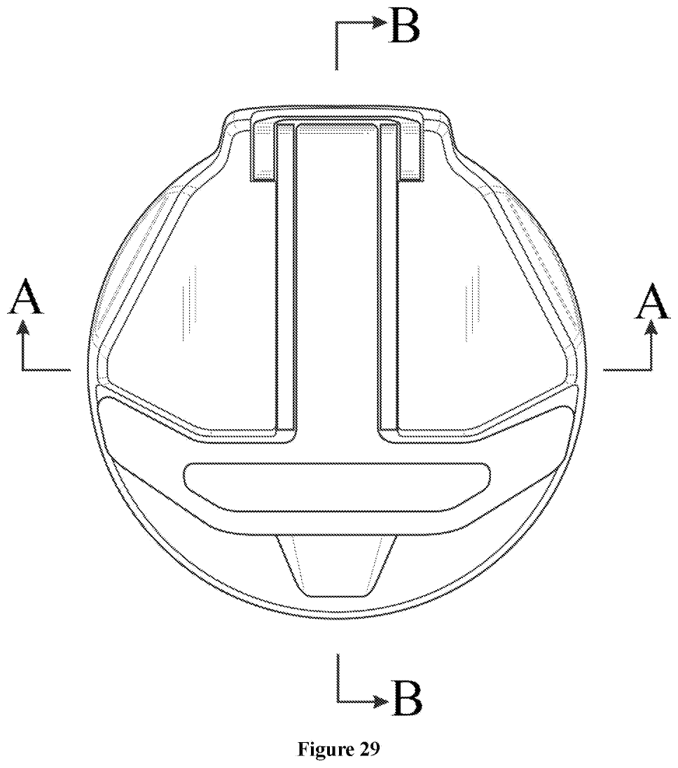

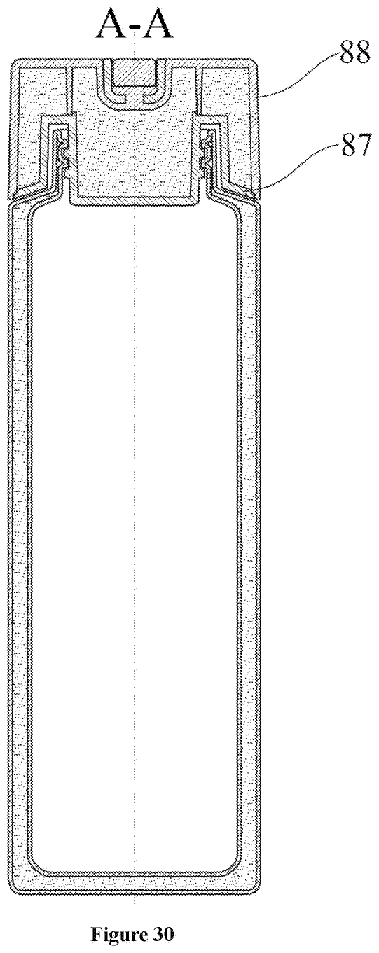

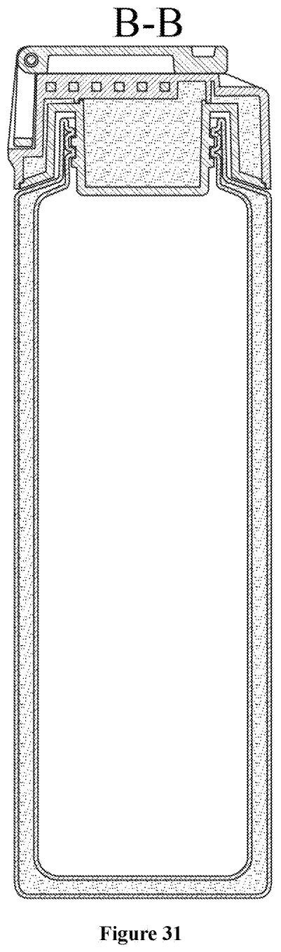

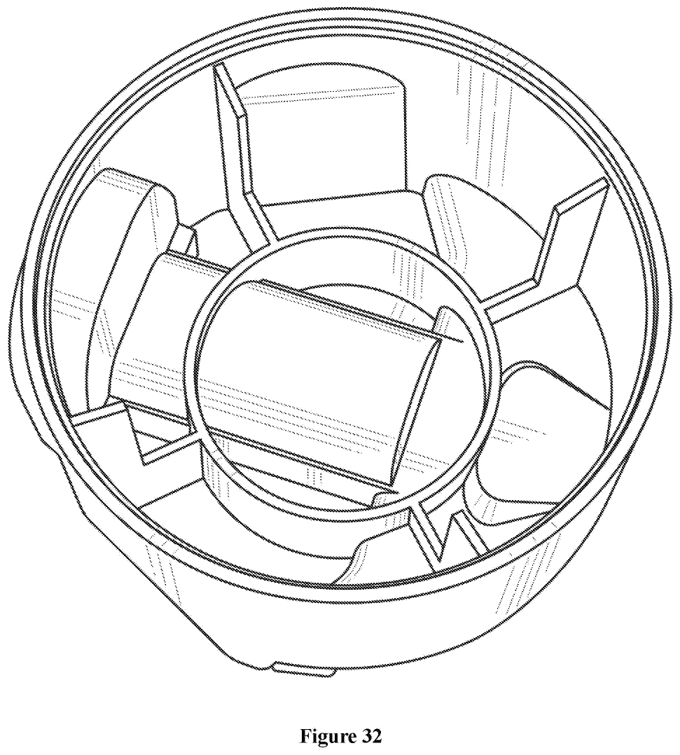

FIGS. 26-32 illustrate a third modification of the basic example of container system 80 as shown in FIGS. 14-17. As compared to FIG. 24, FIG. 26 includes one or two additional finger receptacles 88a on the peripheral wall 88, and a void structure 224 in the handle. In FIG. 27, the lid 81 is disconnected from the container such as a bottle 82 FIG. 28 shows the internal structure of the lid 81. FIG. 29 is a top view of the lid 81 showing two cutting plane lines A-A and B-B. FIG. 30 is a cross-sectional view of the lid 81 along cutting plane A-A. FIG. 31 is a cross-sectional view of the lid 81 along cutting plane B-B. FIG. 32 illustrates the internal structure of the lid 81, after the lower cover 87 is removed.

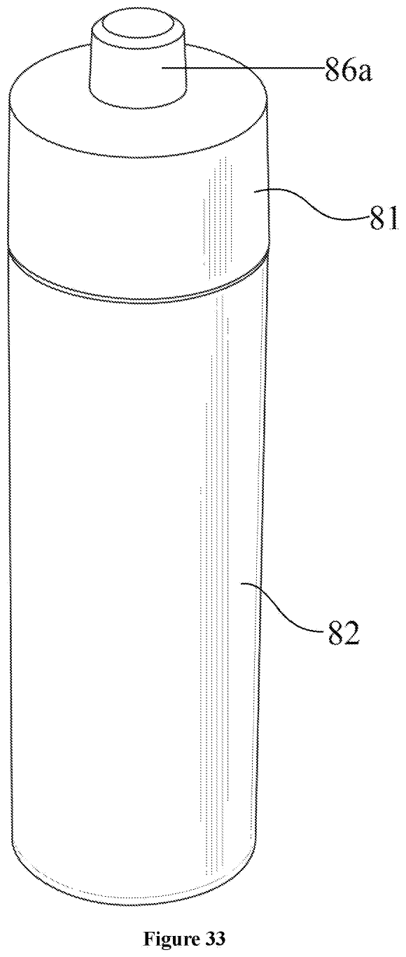

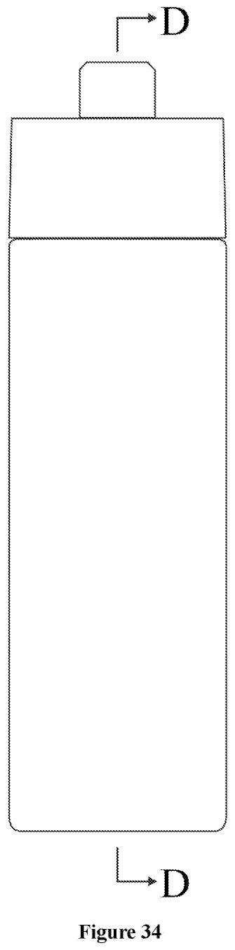

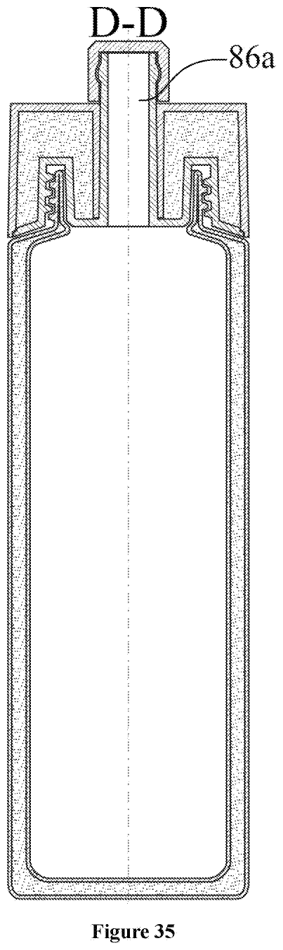

FIGS. 33-35 illustrate a fifth modification of the basic example of container system 80 as shown in FIGS. 14-17. FIG. 33 shows the container system 80 with an outlet opening 86a for releasing liquid content within the container 82. FIG. 34 is a side view of the container system 80 showing a cutting plane line D-D. FIG. 35 is a cross-sectional view of the container system 80 along cutting plane D-D The island 90 may or may not have irregularity or irregularities such as hole(s), groove(s), basin(s), plateau(s), or any combination thereof. For example, the upper cover 86 may have a hole, and the island 90 may also have a hole. An outlet opening 86a is formed through the two holes for releasing liquid content within the container 82.

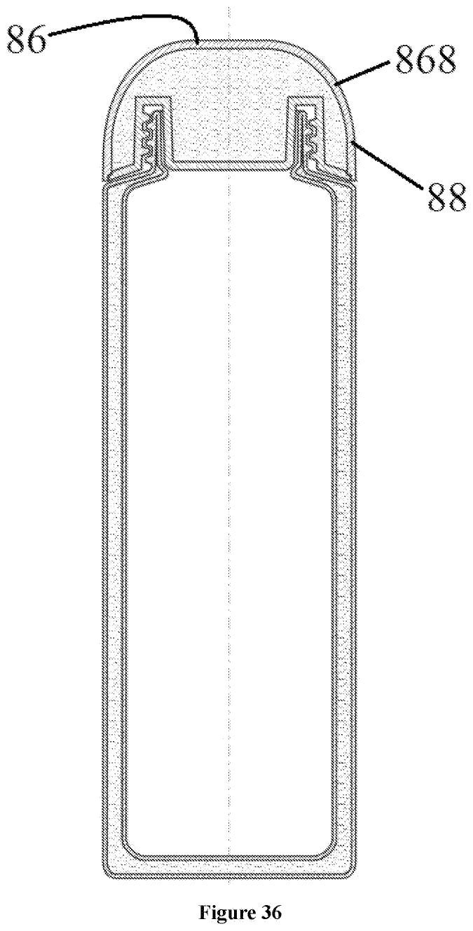

Referring back to FIGS. 14-17, lid 81 comprises an upper cover 86, a lower cover 87, and a peripheral wall 88 (which is preferably closed) located between the upper cover 86 and the lower cover 87 and configured to connect the two covers (86, 87). The transition or junction between the upper cover 86 and the peripheral wall 88 may be angled with an angle between 45° to 135° such as around 90° However, as shown in FIG. 36, the transition or junction between the upper cover 86 and the peripheral wall 88 may be continuously curved (or smooth) without any angle formed between two planes. In other words, the upper cover 86 and the peripheral wall 88 may be shaped like a dome or an up-side-down bowl.

In the foregoing specification, embodiments of the present invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicant to be the scope of the invention, is the literal and equivalent scope of the set of claims that issue from this application, in the specific form in which such claims issue, including any subsequent correction.

1. A container system comprising a lid and a container,
wherein the lid is sized and configured to be attached to the container;
wherein the container is Tillable or filled with a human drink such as water, coffee, beverages, sodas, and juices;
wherein the container comprises a mouth having an opening defined by a cylindrical neck wall for dispensing the human drink; and
wherein the lid comprises an upper cover, a lower cover, and a peripheral wall located between the upper cover and the lower cover and configured to connect said two covers;
wherein the lower cover comprises a circular trench (upside-down) surrounding a round island (upside-down);
wherein the cylindrical wall of the mouth is configured to insert into the circular trench, while the island is configured to plug into the opening;
wherein the circular trench is within the peripheral wall, and a space is formed between the peripheral wall and an outer vertical wall of the circular trench; and
wherein at least said space is vacuum insulated, or it is filled with foam, air, or any combination thereof.

2. The container system according to claim 1, wherein the entire space enclosed by the upper cover, lower cover, and the peripheral wall is vacuum insulated, or it is filled with air, foam, or any combination thereof.

3. The container system according to claim 1, wherein the lower cover includes, from the outermost to the innermost, a trench outward bank, a trench outer vertical wall, a trench base, a trench inner vertical wall, a trench inward bank which is also the circumference region of the round island, and the central region of the round island.

4. The container system according to claim 3, wherein the trench outward bank is flat, curved, angled, or just a point of intersection of the peripheral wall and the outer vertical wall of the circular trench.

5. The container system according to claim 1, further comprising one or more reinforcement partition members within the space enclosed by the upper cover, the lower cover, and the peripheral wall.

6. The container system according to claim 5, comprising two or more reinforcement partition members, wherein any two of these partition members are separated from each other or connected to each other.

7. The container system according to claim 1, wherein the upper cover is substantially flat and round, and wherein the peripheral wall is substantially cylindrical; or wherein the upper cover and the peripheral wall in combination have a shape of dome or up-side-down bowl.

8. The container system according to claim 1, wherein the upper cover has irregularity or irregularities such as hole(s), groove(s), basin(s), plateau(s), or any combination thereof; wherein the island has irregularity or irregularities such as hole(s), groove(s), basin(s), plateau(s), or any combination thereof; and/or wherein the peripheral wall has irregularity or irregularities such as hole(s), cavity or cavities, flat(s), groove(s), or any combination thereof.

9. The container system according to claim 8, wherein the upper cover has a hole, the island has a hole, and an outlet opening is formed through the two holes for releasing liquid content within the container.

10. The container system according to claim 1, wherein the upper cover is included in a first single molded piece, the peripheral wall is included in a second single molded piece, and the lower cover is included in a third single molded piece.

11. The container system according to claim 1, wherein the upper cover and the peripheral wall are included in a single molded piece, and the lower cover is included in another single molded piece.

12. The container system according to claim 1, wherein the lower cover and the peripheral wall are included in a single molded piece, and the upper cover is included in another single molded piece.

13. The container system according to claim 1, wherein the upper cover and a part of the peripheral wall are included in a single molded piece; and the lower cover and the remaining part of the peripheral wall are included in a single molded piece.

14. The container system according to claim 5, wherein the one or more reinforcement partition members and the upper cover are included in a single molded piece.

15. The container system according to claim 5, wherein the one or more reinforcement partition members and the lower cover are included in a single molded piece.

16. The container system according to claim 5, wherein the one or more reinforcement partition members and the peripheral wall are included in a single molded piece.

17. The container system according to claim 5, wherein the one or more reinforcement partition members are separated into two or three parts, and wherein said two or three parts and any 2 or all 3 of the upper cover, the lower cover, and the peripheral wall are included in 2 or 3 single molded pieces, respectively.

18. The container system according to claim 1, wherein the cylindrical wall of the mouth is fastened/secured to the circular trench by any attaching or fastening structures, such as a threaded connection (e.g. neck finish), a friction fit, interference fit, snap fit, fastener, clips, a bayonet attachment, or any combination thereof.

19. The container system according to claim 18, wherein the cylindrical wall of the mouth has an internal wall and an external wall.

20. The container system according to claim 19, wherein the attaching or fastening structure comprises threads on the internal wall and complimentary threads on the trench inner vertical wall.

21. The container system according to claim 19, wherein the attaching or fastening structure comprises threads on the external wall and complimentary threads on the trench outer vertical wall.

22. The container system according to claim 5, wherein the one or more reinforcement partition members are substantially vertical.

23. The container system according to claim 22, wherein the one or more reinforcement partition members comprise a flat partition member, a curved partition member, a circular partition member, or any combination thereof.

24. The container system according to claim 23, wherein the flat partition member is extended along a chord direction of the circular trench or the round island, but not along a direction radial from the center of the circular trench or the round island.

25. The container system according to claim 23, wherein the flat partition member is extended along a direction radial from the center of the circular trench or the round island.

26. The container system according to claim 23, wherein the flat partition member is extended along a diameter direction of the circular trench or the round island.

27. The container system according to claim 23, wherein a plurality (e.g. 4 or more) of the flat partition members that are extended along a chord direction of the circular trench or the round island (but not along a direction radial from the center thereof) form a grid of partition members.

28. The container system according to claim 23, wherein (A) a plurality (e.g. 4 or more) of the flat partition members that are extended along a chord direction of the circular trench or the round island (but not along a direction radial from the center thereof) form a grid of partition members, and (B) one or two flat partition members that are extended along a diameter direction of the circular trench or the round island, form a grid of partition members.

29. The container system according to claim 23, wherein the circular partition member is not concentrical with the circular trench or the round island.

30. The container system according to claim 23, wherein the circular partition member is concentrical with the circular trench or the round island.

31. The container system according to claim 5, wherein the one or more reinforcement partition members divide the space enclosed by the upper cover, lower cover, and the enclosed wall into two or more chambers.

32. The container system according to claim 31, wherein the two or more chambers are completely separated or partially connected.

33. The container system according to claim 32, wherein the two or more chambers are vacuum insulated, or they are filled with air, foam, or any combination thereof.
